(19) United States
(12) Patent Application Publication
(10) Pub. No.: US 2026/0366369 A1
(43) Pub. Date: Nov. 19, 2026

(54) WINDOW BLIND ENHANCEMENT

(71) Applicant: JACK A. MITCHELL, BRIGHTON (CA)

(72) Inventor: JACK A. MITCHELL, BRIGHTON (CA)

(21) Appl. No.: 19/676,956

(22) Filed: May 14, 2026

Related U.S. Application Data
(60) Provisional application No. 63/806,395, filed on May 15, 2025.

(51) Int. Cl. E06B 9/325

(52) U.S. Cl. CPC E06B 9/325

(57) ABSTRACT

A window blind enhancement is for use with a blind. The blind enhancement includes a shaft and a grasp and release mechanism operably attached to the shaft. The shaft has a distal end and a proximal end. The shaft is operably connected to the blind. The shaft is moveable relative to the blind. The shaft is configured to be movable from an engaged position to a disengaged position. In the engaged position the shaft extends outwardly from the side of the blind and the distal end of the shaft operably engages the window frame. In the disengaged position the shaft is disengaged from the window frame. The blind enhancement may be constructed as a separate unit that is attachable to a blind or constructed in the bottom rail of the blind.

### BACKGROUND

The present disclosure relates to a blind enhancement for use with a window blind to keep the blind in position and to reduce the likelihood of swaying and knocking against the window frames in a breeze.

As many know, when a blind is in the closed position and the window that it is covering is open, allowing a breeze into the room the blind will typically sway back and forth in the breeze. This may cause an annoying knocking of the blind against the window frames. Accordingly, it would be advantageous to provide a blind enhancement that holds the blind in position and reduces the likelihood of the blind to sway and knock in a breeze.

### SUMMARY

A window blind enhancement is for use with a blind. The blind has sides and is positioned in the window frame. The shaft has a distal end and a proximal end. The shaft is operably connected to the blind. The shaft is moveable relative to the blind. The blind enhancement may include a shaft and a grasp and release mechanism operably attached to the shaft, wherein the grasp and release mechanism is configured to selectively hold the shaft in an engaged position. The shaft is configured to be movable from an engaged position to a disengaged position. In the engaged position the shaft extends outwardly from the side of the blind and the distal end of the shaft operably engages the window frame. In the disengaged position the distal end of the shaft is disengaged from the window frame.

The window blind may include a housing wherein the shaft is moveable within the housing and the housing is connectable to the blind.

The blind may have a bottom rail and the shaft may be moveable within the bottom rail.

The window blind enhancement may include a stopper operably attached to the distal end of the shaft.

The window blind enhancement may further include a biasing member configured to bias the shaft toward the engagement position.

The grasp and release mechanism may be a ratchet mechanism. The ratchet mechanism may include a toothed portion and a pawl configured to move from an engaged position wherein the pawl engages the toothed portion and a release position where the toothed portion moves freely. The ratchet mechanism toothed portion may be integrally formed in the shaft. The window blind enhancement may include a release button to move the pawl from an engage position to release position.

The grasp and release mechanism may be a friction hold type mechanism. The friction hold type mechanism may include a pair of arms biased into a closed position. A pair of springs may be configured to bias the pair of arms toward the closed position.

The grasp and release mechanism may be a detent type mechanism. The detent type mechanism may include a plurality of holes formed in the shaft and an arm having an end configured to selectively engage one of the plurality of holes. The window blind enhancement may further include a spring to bias the arm in the engaged position.

A method for securing a window blind within a window frame, the method comprising the steps of: providing a blind enhancement operably connected to the blind, the enhancement comprising a shaft and a grasp and release mechanism operably attached to the shaft; moving the shaft from a disengaged position to an engaged position wherein a distal end of the shaft extends outwardly from a side of the blind to operably engage the window frame; and engaging the grasp and release mechanism to hold the shaft in the engaged position.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 is a perspective view of a blind having a blind enhancement attached thereto;

FIG. 2 is an enlarged perspective view of the blind enhancement shown in FIG. 1 but showing the housing in phantom;

FIG. 3 is an exploded view of the blind enhancement shown in FIGS. 1 and 2;

FIG. 4A is a sectional view of the blind enhancement of FIG. 2;

FIG. 4B is a sectional view of the blind enhancement similar to that shown in FIG. 4A showing the direction of motion of the shaft;

FIG. 4C is a sectional view of the blind enhancement similar to that shown in FIGS. 4A and 4B but showing the blind accessory in the engaged position;

FIG. 4D is a sectional view of the blind enhancement similar to that shown in FIGS. 4A, 4B and 4C but shown in the disengaged position;

FIG. 5 is a sectional view of the blind enhancement friction similar to that shown in FIG. 4A but showing an alternate grasp and release mechanism;

FIG. 6 is a sectional view of the blind enhancement friction similar to that shown in FIGS. 5 and 4A but showing further alternate grasp and release mechanism; and

FIG. 7 is a perspective view of a blind enhancement integrally formed within a blind.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the term “grasp and release mechanism” refers to any mechanism capable of selectively holding the shaft in a fixed position relative to the housing or blind and allowing the shaft to be selectively released from that fixed position. The grasp and release mechanism may include, but is not limited to, a ratchet mechanism, a friction-hold mechanism, a detent mechanism, or any other suitable mechanical latch or catch.

As used herein, a “biasing member” refers to any component configured to apply a force to urge the shaft toward a particular position, such as the engaged or disengaged position. A biasing member may include, but is not limited to, a mechanical spring (such as a coil spring or leaf spring), an elastomeric member, a pneumatic or hydraulic element, or a magnetic element.

As used herein, a “stopper” refers to a component attached to or formed on the distal end of the shaft configured to provide a non-marring and/or friction-enhancing contact surface for engaging the window frame.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein the “operably connected” or “operably attached” means that the two elements are connected or attached either directly or indirectly. Accordingly, the items need not be directly connected or attached but may have other items connected or attached therebetween.

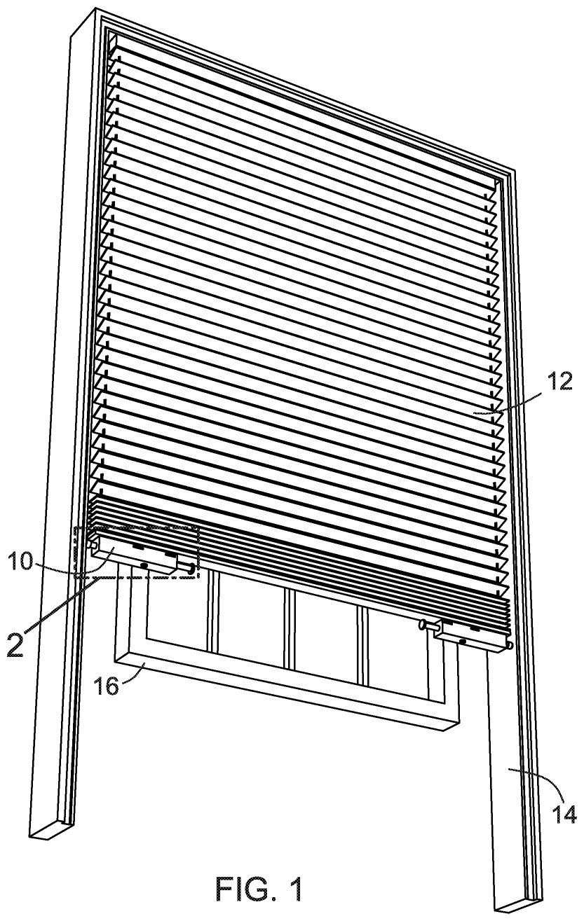

Referring to FIG. 1, a blind enhancement 10 is for use with a blind 12 that is positioned in a window frame 14 around the window 16. In use, a pair of blind enhancements 10 will be attached on either side of the blind 12. Each blind enhancement 10 is operably attached to a blind 12 so that it holds the blind in position which reduces the likelihood of the blind swaying in the breeze and hitting the window frame 14.

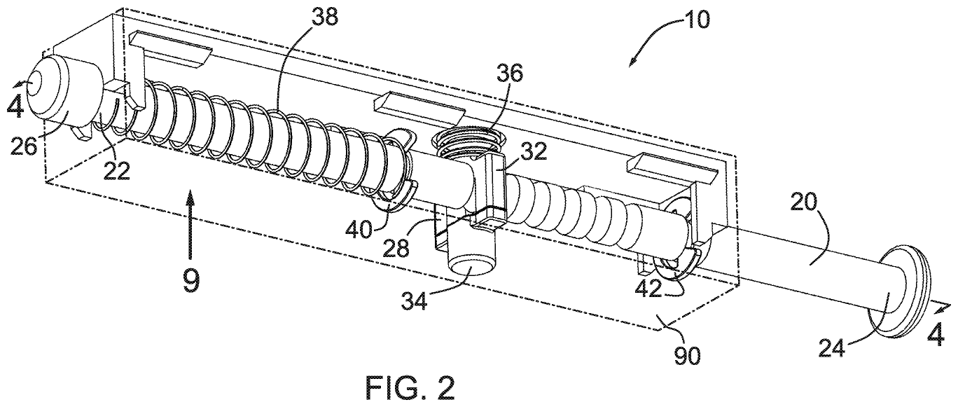

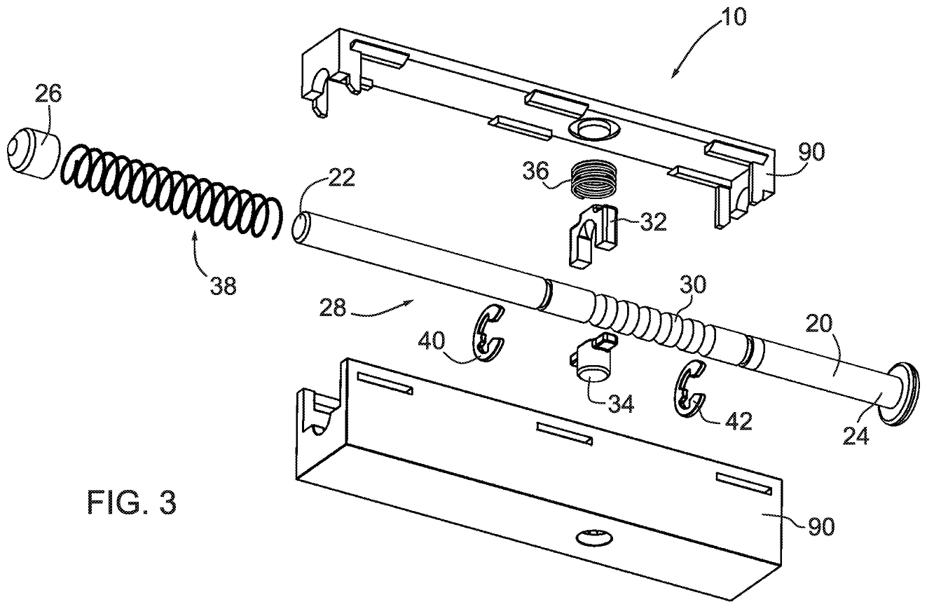

Referring to FIGS. 2 and 3 the blind enhancement 10 includes a shaft 20 that has a distal end 22 and a proximal end 24. The distal end 22 may have a stopper 26 attached thereto. Preferably, the stopper 26 is made from soft material, such as a thermoplastic elastomer, silicone or rubber that will not scratch the window frame 14 and allow slight compression for the pawl 32 to fit into the tooth 30 snuggly.

A grasp and release mechanism is operably attached to the shaft 20. In the embodiment shown in FIGS. 2 and 3, the grasp and release mechanism is a ratchet mechanism 28. The ratchet mechanism 28 includes a toothed portion 30 which is integrally formed in the shaft 20. A pawl 32 is configured to move from an engage position wherein the pawl engages the toothed portion and a release position wherein the toothed portion can move freely. A release button 34 is moveable such that the release button can move the pawl 32 from an engage position to the release position. In other embodiments, the release button 34 may be a slide, a lever or other type of actuator.

The ratchet mechanism 28 includes a pawl biasing mechanism to bias the pawl into the engagement position. The pawl biasing mechanism may be a spring 36.

The shaft 20 is biased outwardly so that when the blind enhancement is operably attached to the blind 12 it extends outwardly from the side of the blind 12. The shaft biasing mechanism includes a biasing member, such as a shaft spring 38 and a retaining ring 40 operably attached to the shaft 20. A guide ring 42 is operably attached to the shaft 20 and limits the movement of the shaft 20.

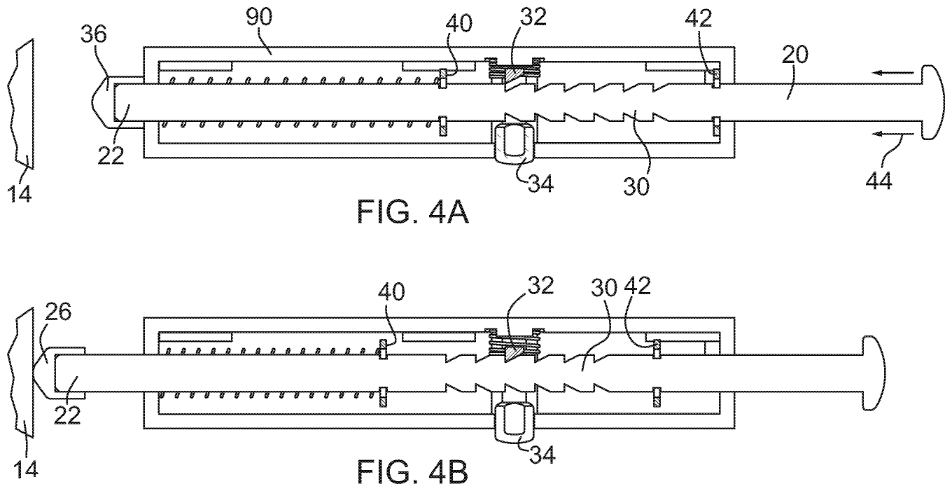

FIGS. 4A, 4B, 4C and 4D show the different stages of use. The shaft 20 of the blind enhancement is configured to move from an engaged position to a disengaged position. The first stage is shown in FIG. 4A when the shaft 20 is in the disengaged position. The arrows 44 show the direction of motion to move the shaft from the disengaged position to the engaged position. The user then pushes on the proximal end 24 of the shaft 20, as shown in FIG. 4B. The shaft 20 is pushed such that distal end 22 engaged the window frame 14. The pawl 32 engages the tooth portion 30 of the ratchet and holds the shaft 20 in position. The biasing mechanism, spring 38, is configured to apply force outwardly from the blind 12. When the user wants to release the blind enhancement 10, force is applied to the release button 34 which in turn applies force to the pawl thereby moving the pawl from an engage position to a release position as shown in FIG. 4C. When the pawl is in the disengaged position the shaft 20 can move freely and spring 38 pushes the shaft into the disengaged position. The disengaged position is shown in FIG. 4D wherein the distal end of the shaft 20 is spaced from window frame 14.

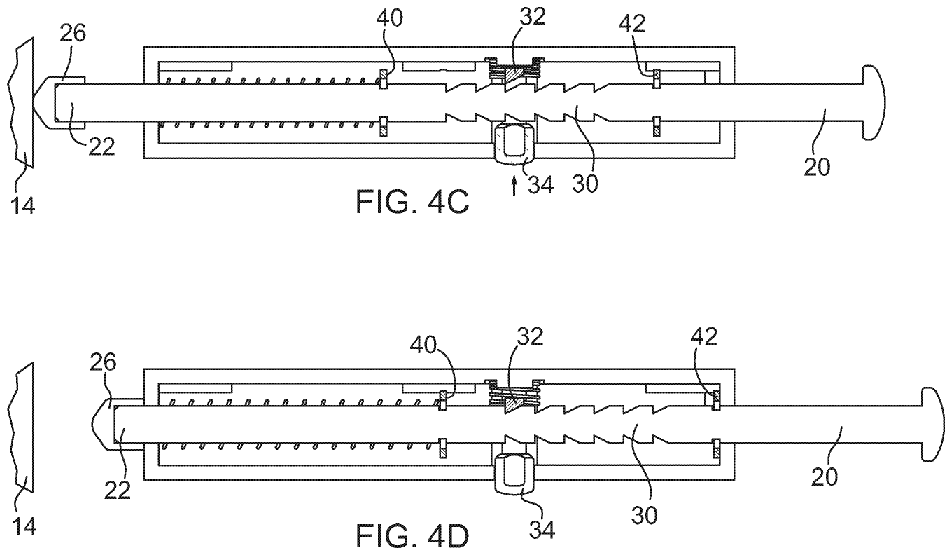

The specific embodiments described above have been shown by way of example, and it should be understood that these embodiments may be subject to various modifications and alternative forms. For example, as shown in FIG. 5, the grasp and release mechanism may be a friction hold type mechanism 60. The friction hold type mechanism 60 includes a pair of arms 62 which are biased into a closed position. A pair of springs 64 bias the pair of arms 62 in a closed position.

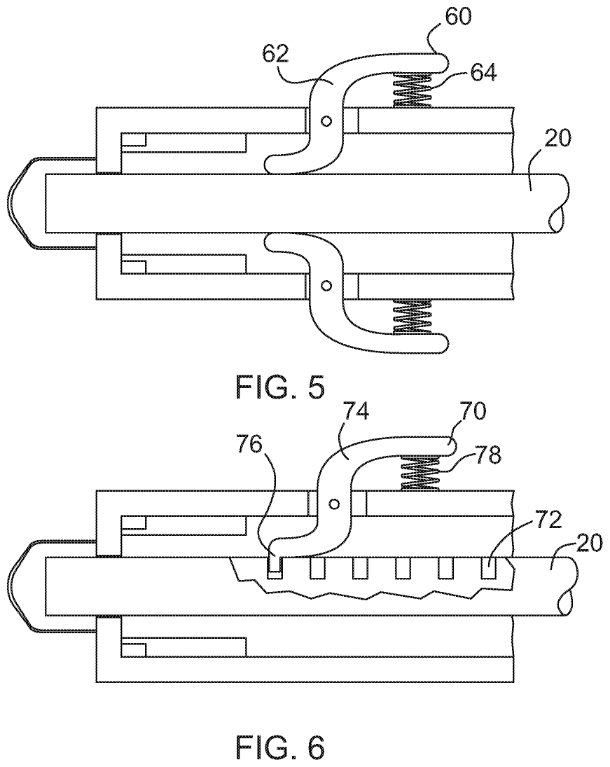

Alternatively, the grasp and release mechanism is a detent type mechanism 70 as shown in FIG. 6. The detent type mechanism 70 includes a plurality of holes 72 formed in the shaft 20. An arm 74 has an end 76 configured to selectively engage one of the plurality of holes 72. The arm 74 is biased in the engaged position with a spring 78.

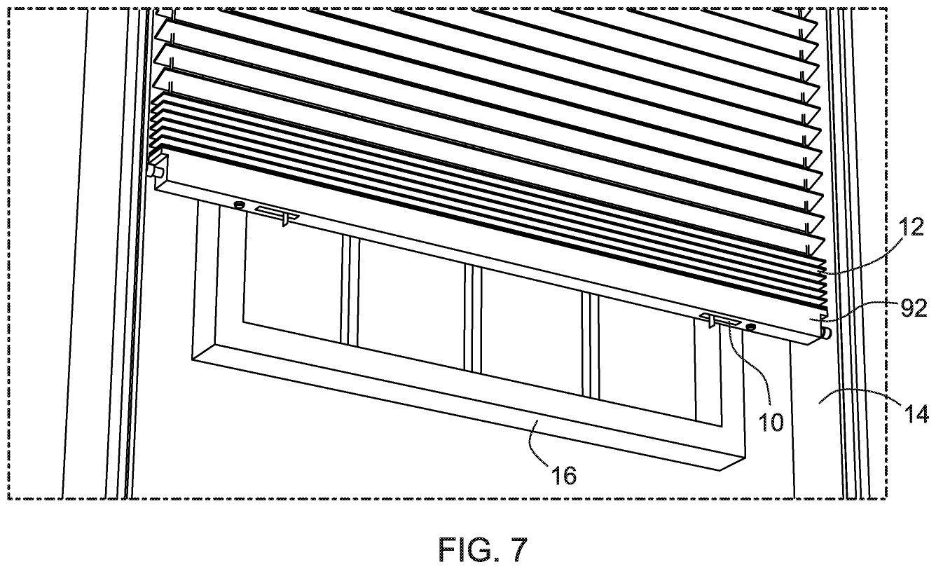

The blind enhancement 10 may be constructed as a separate unit that is attachable to a blind 12. When constructed as a separate unit the blind enhancement is in a housing 90 as shown in FIGS. 1 to 6. The housing 90 and other components may be formed from durable polymer, such as ABS or polycarbonate, through processing like injection molding. The separate may be attached to the blind 12 using mechanical fasteners, adhesives or a clip mechanism. Alternatively, the blind enhancement 10 may be constructed in the bottom rail 92 of the blind 12 as shown in FIG. 7. In such an integrated embodiment, the components of the blind enhancement may be co-molded with bottom rail or assembled within a cavity formed therein. In use, a pair of blind enhancements 10 are attached to either side of the blind 12 or constructed in the bottom rail 92 on either side thereof.

The blind enhancement 10 is used to hold the blind 12 in a position in the window frame 14 so that it does not blow and bang in a breeze onto or against the window frame.

It should be further understood that the claims are not intended to be limited to the particular forms disclosed, but rather to cover all modifications, equivalents, and alternatives falling within the spirit and scope of this disclosure. For example, while the shaft is shown as cylindrical, it may have other cross-sectional shapes, such as square or rectangular. Likewise, the dimensions and materials of all components may be varied to suit different blind sizes and styles without departing from the scope of the invention.

1. A window blind enhancement for use with a blind having sides and being positioned in a window frame, the bind enhancement comprising:
a shaft having a distal end and a proximal end, the shaft being operably connected to the blind and being configured to be moveable relative to the blind;
a grasp and release mechanism operably attached to the shaft, wherein the grasp and release mechanism is configured to selectively hold the shaft in an engaged position; and
whereby the shaft is configured to be movable from an engaged position extending outwardly from a side of the blind, wherein the distal end of the shaft operably engages the window frame, to a disengaged position wherein the distal end of the shaft is disengaged from the window frame.

2. The window blind enhancement as claimed in claim 1 further including a housing wherein the shaft is moveable within the housing and the housing is connectable to the blind.

3. The window blind enhancement as claimed in claim 1 wherein the blind has a bottom rail and the shaft is moveable within the bottom rail.

4. The window blind enhancement as claimed in claim 1 further including a stopper operably attached to the distal end of the shaft.

5. The window blind enhancement as claimed in claim 1 further including a biasing member configured to bias the shaft toward the engagement position.

6. The window blind enhancement as claimed in claim 1 wherein the grasp and release mechanism comprises a ratchet mechanism.

7. The window blind enhancement as claimed in claim 6 wherein the ratchet mechanism includes a toothed portion and a pawl configured to move from an engaged position wherein the pawl engages the toothed portion and a release position where the toothed portion moves freely.

8. The window blind enhancement as claimed in claim 7 wherein the ratchet mechanism toothed portion is integrally formed in the shaft.

9. The window blind enhancement as claimed in claim 7 further including a release button to move the pawl from the engaged position to the release position.

10. The window blind enhancement as claimed in claim 1 wherein the grasp and release mechanism is a friction hold type mechanism.

11. The window blind enhancement as claimed in claim 10 wherein the friction hold type mechanism includes a pair of arms biased into a closed position.

12. The window blind enhancement as claimed in claim 11 further comprising a pair of springs configured to bias the pair of arms toward the closed position.

13. The window blind enhancement as claimed in claim 1 wherein the grasp and release mechanism is a detent type mechanism.

14. The window blind enhancement as claimed in claim 13 wherein the detent type mechanism includes a plurality of holes formed in the shaft and an arm having an end configured to selectively engage one of the plurality of holes.

15. The window blind enhancement as claimed in claim 14 further comprising a spring configured to bias the arm in the engaged position.

16. A method for securing a window blind within a window frame, the method comprising the steps of:
providing a blind enhancement operably connected to the blind, the enhancement comprising a shaft and a grasp and release mechanism operably attached to the shaft;
moving the shaft from a disengaged position to an engaged position wherein a distal end of the shaft extends outwardly from a side of the blind to operably engage the window frame; and
engaging the grasp and release mechanism to hold the shaft in the engaged position.
